(19) United States
(12) Patent Application Publication
(10) Pub. No.: US 2021/0319962 A1
(43) Pub. Date: Oct. 14, 2021

(54) PLUGGABLE MULTIFUNCTIONAL PUSH SWITCH

(71) Applicant: Ching-Hsiung CHU, New Taipei City (TW)

(72) Inventor: Ching-Hsiung CHU, New Taipei City (TW)

(21) Appl. No.: 16/847,681

(22) Filed: Apr. 14, 2020

(51) Int. Cl. H01H 9/08; H01H 13/14; H01H 13/02

(52) U.S. Cl. CPC H01H 9/08; H01H 13/023; H01H 13/14

(57) ABSTRACT

The present invention provides a pluggable multifunctional push switch, comprising: a main socket, a transmission opening disposed on a bottom wall of the main socket; a sliding base, slid up and down in the main socket; a pressing signal assembly, the sliding base triggering a pressing signal after being pressed downward; a keycap, fixed on the sliding base; an integrated circuit board, disposed into the sliding base and having a downwardly extended transmission member, wherein a bottom end of the transmission member has a plug-in portion; a fixed base, disposed on the integrated circuit board; a display, disposed on the fixed base; and a touchpad, located under the keycap. The pluggable transmission concept is further used in the present invention, so that the switch can be more easily disassembled and easily transferred to another device for use.

### FIELD OF INVENTION

The present invention relates to a pluggable multifunctional push switch; in particular, the present invention relates to a push switch generating two independent signals by physical pressing and touch sensing.

### BACKGROUND OF THE INVENTION

On all kinds of electronic products, it is often seen that the buttons are pressed to generate signals to start and control some functions, and the specifications and sizes of switches are very diverse in size and variety, and the application range is quite wide. In order to allow the users to confirm whether their pressing is correct, there is also a switch with a light-emitting element, which can generate light for confirmation after pressing.

The switches commonly used in general precision equipment, small equipment or small appliances are generally opened and closed by physical pressing. With the development of touch technology, inductive switches that is able to sense the static electricity from the human body. Both have their advantages, but one switch can usually only output one signal, which also limits the use of the switch.

In addition, the conventional switches installed in precision equipment, small equipment, or small appliances are mainly through metal conductive wires or conductive pins for connection and signal transmission. However, in this type of contact equipment, if a switch fails, the switch needs to be dismantled for repair, and the original welding point will need to be removed. The more multi-function switches with more control functions, the more points will be necessary to be connected. Maintenance and disassembly will be very inconvenient, and there are many deficiencies.

In aforementioned type of switch, it could only be fixed to a single machine for use, but could not be transferred to other machine by plugging and unplugging. This is a limitation.

The above information disclosed in this section is only for enhancement of understanding of the background of the described technology and therefore it may contain information that does not form the prior art that is already known to a person of ordinary skill in the art.

### SUMMARY OF THE INVENTION

In view of the above-mentioned deficiencies of the conventional technology, the present invention is to design a switch with LED lights having patentability, novelty and industrial utilization, to overcome the difficulties of the conventional technology.

The present invention provides a pluggable multifunctional push switch, comprising: a main socket, an upper end of the main socket having an open hollow housing, and a transmission opening disposed on a bottom wall of the main socket; a sliding base, being a hollow housing with an open upper end and an open lower end, passed through the main socket, and slid up and down in the main socket, wherein at least one resetting spring is set between the main socket and sliding base; a pressing signal assembly, disposed between the main socket and the sliding base, and the sliding base triggering a pressing signal after being pressed downward; a keycap, fixed on the sliding base, wherein a surface of the keycap is transparent; an integrated circuit board, disposed into the sliding base and having a downwardly extended transmission member, wherein a bottom end of the transmission member has a plug-in portion, and a upward LED light source is disposed on the integrated circuit board; a fixed base, disposed on an upper side of the integrated circuit board, wherein a position of the fixed base corresponding to the LED light source is transparent; a display, disposed on the fixed base and being not overlapped with a position of the LED light source, and the display electrically connected to the integrated circuit board; and a touchpad, located under the keycap and electrically connected to the integrated circuit board.

In the embodiment of the present invention, the pressing signal assembly further has a transmission portion, which extends from the bottom wall of the main socket.

In the embodiment of the present invention, the plug-in portion is fixed at the transmission opening of the main socket to provide a pluggable fixing method.

The pluggable multifunctional push switch of the present invention mainly designed corresponds to a switch button which provides two signal outputs for pressing signal and touch signal, so as to achieve the functions of the physical touch and the sensing touch, and increase the flexibility of operation in a limited space. For example, the touch signal can be used to confirm that the pressing signal is activated by the user pressing the button, and avoiding other people mistakenly pressing the switch to cause turn on or turn off the device.

In addition, the switch of the present invention has a structure with a light, so it can be used to light up a prompting effect for operation after pressing, or as a prompting light source in an environment where the light source is insufficient, which increases the diversity of applications. Furthermore, the pluggable transmission concept is further used, so that the switch of the present invention can be more easily disassembled. The switch of the present invention has the characteristics of easy maintenance, or can be easily transferred to another device for use, which is not available to the conventional technology.

Many of the attendant features and advantages of the present invention will become better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is an appearance diagram of a pluggable multifunctional push switch of the present invention.

FIG. 2 is an appearance diagram from another perspective of the pluggable multifunctional push switch of the present invention.

FIG. 3 is an appearance exploded diagram of the pluggable multifunctional push switch of the present invention.

FIG. 4 is an appearance exploded diagram from another perspective of the pluggable multifunctional push switch of the present invention.

FIG. 5 is a sectional diagram of the pluggable multifunctional push switch of the present invention.

FIG. 6 is a sectional diagram from another perspective of the pluggable multifunctional push switch of the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The following descriptions are provided to elucidate a switch with LED lights and to aid it of skilled in the art in practicing this invention. These Examples are merely exemplary embodiments and in no way to be considered to limit the scope of the invention in any manner.

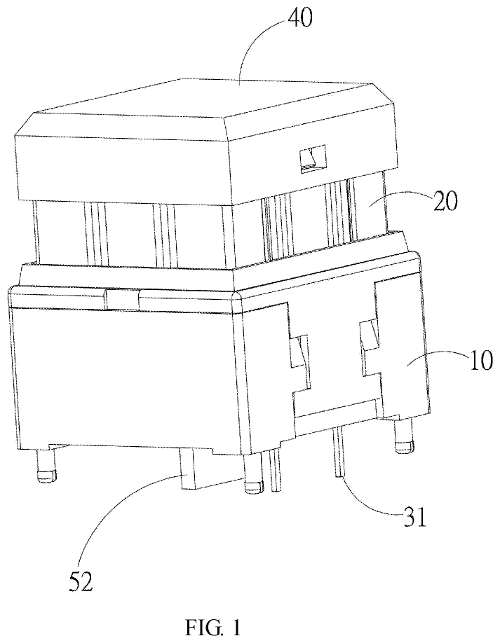

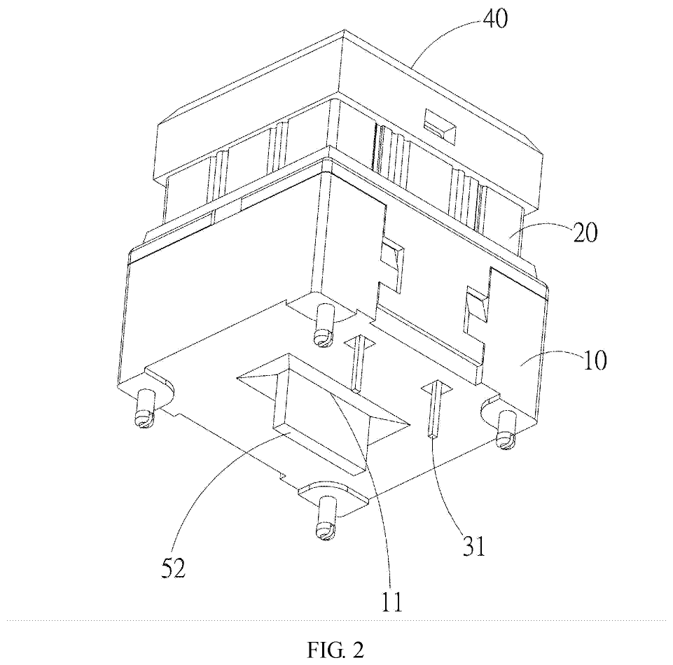

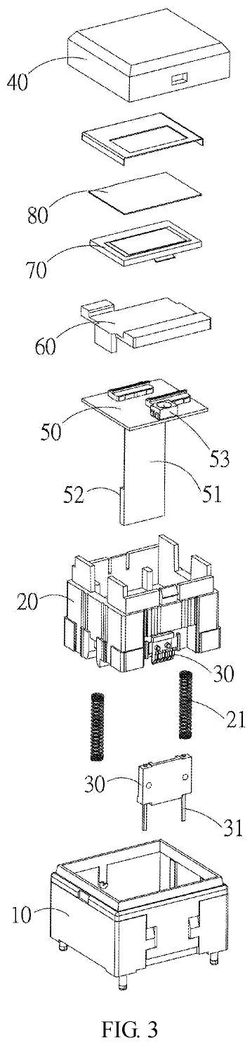

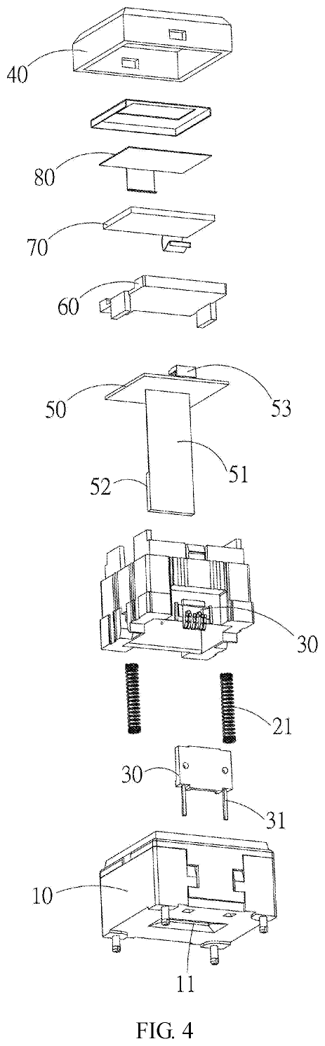

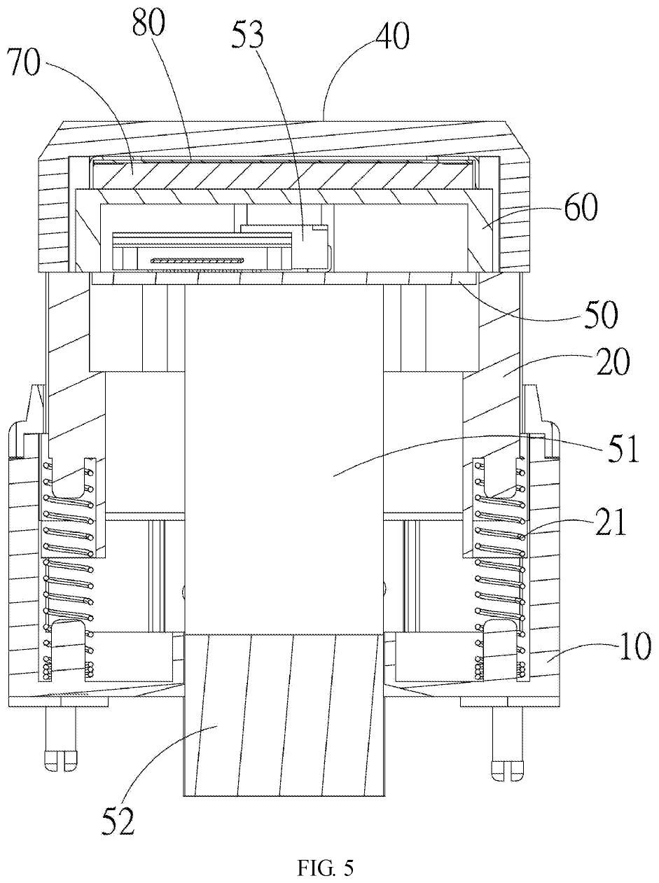

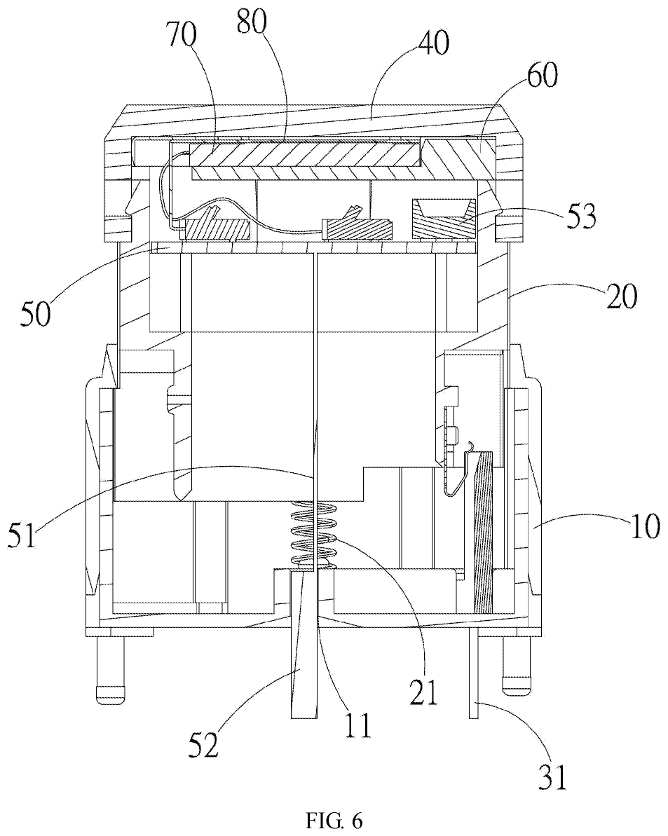

Please refer to FIG. 1-FIG. 6, the present invention provides a pluggable multifunctional push switch, comprising: a main socket 10, a sliding base 20, a pressing signal assembly 30, a keycap 40, an integrated circuit board 50, a fixed base 60, a display 70, a touchpad 80.

An upper end of the main socket 10 is an open hollow housing, and a transmission opening 11 is disposed on a bottom wall of the main socket 10.

The sliding base 20 is a hollow housing with an open upper end and an open lower end. The sliding base 20 passes through the main socket 10 and can slide up and down in the main socket 10. At least one resetting spring 21 is set between the main socket 10 and sliding base 20, and the resetting force for returning to the original position can be generated after the sliding base 20 is pressed down by a force.

The pressing signal assembly 30 is disposed between the main socket 10 and the sliding base 20, and the sliding base 20 can trigger a pressing signal after being pressed downward. The pressing signal assembly 30 further has a transmission portion 31, which extends from the bottom wall of the main socket 10.

The keycap 40 is fixed on the sliding base 20 for users to press, and a surface of the keycap 40 for pressing is transparent.

An integrated circuit board 50 is disposed into the sliding base 20, and has a transmission member 51, which can be downwardly extended and a cable, and a bottom end of the transmission member 51 has a plug-in portion 52. The plug-in portion 52 may be fixed at the transmission opening 11 of the main socket 10 to provide a pluggable fixing method as a transmission means. In addition, a LED light source 53 is disposed on the integrated circuit board 50, and a direction of light source is upward.

The fixed base 60 is disposed on an upper side of the integrated circuit board 50, and a position of the fixed base 60 corresponding to the LED light source 53 is transparent, so that the light source can penetrate through the keycap 40.

The display 70 is disposed on the fixed base 60 and does not overlap with a position of the LED light source 53, and the display 70 is electrically connected to the integrated circuit board 50.

The touchpad 80 is located under the keycap 40 and is electrically connected to the integrated circuit board 50. The touchpad 80 can be a capacitive touch. When the user presses it, a control signal is generated and sent out.

The pluggable multifunctional push switch of the present invention mainly designed corresponds to a switch button which provides two signal outputs for pressing signal and touch signal, so as to achieve the functions of the physical touch and the sensing touch, and increase the flexibility of operation in a limited space. For example, the touch signal can be used to confirm that the pressing signal is activated by the user pressing the button, and avoiding other people mistakenly pressing the switch to cause turn on or turn off the device.

In addition, the switch of the present invention has a structure with a light, so it can be used to light up a prompting effect for operation after pressing, or as a prompting light source in an environment where the light source is insufficient, which increases the diversity of applications. Furthermore, the pluggable transmission concept is further used, so that the switch of the present invention can be more easily disassembled. The switch of the present invention has the characteristics of easy maintenance, or can be easily transferred to another device for use, which is not available to the conventional technology.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations or modifications to the disclosed embodiments without departing from the spirit or scope of this invention.

What is claimed is:

1. A pluggable multifunctional push switch, comprising:
a main socket, an upper end of the main socket having an open hollow housing, and a transmission opening disposed on a bottom wall of the main socket;
a sliding base, being a hollow housing with an open upper end and an open lower end, passed through the main socket, and slid up and down in the main socket, wherein at least one resetting spring is set between the main socket and sliding base;
a pressing signal assembly, disposed between the main socket and the sliding base, and the sliding base triggering a pressing signal after being pressed downward;
a keycap, fixed on the sliding base, wherein a surface of the keycap is transparent;
an integrated circuit board, disposed into the sliding base and having a downwardly extended transmission member, wherein a bottom end of the transmission member has a plug-in portion, and a upward LED light source is disposed on the integrated circuit board;
a fixed base, disposed on an upper side of the integrated circuit board, wherein a position of the fixed base corresponding to the LED light source is transparent;
a display, disposed on the fixed base and being not overlapped with a position of the LED light source, and the display electrically connected to the integrated circuit board; and
a touchpad, located under the keycap and electrically connected to the integrated circuit board.

2. The switch as defined in claim 1, wherein the pressing signal assembly further has a transmission portion, which extends from the bottom wall of the main socket.

3. The switch as defined in claim 1, wherein the plug-in portion is fixed at the transmission opening of the main socket to provide a pluggable fixing method.
